(19) United States
(12) Patent Application Publication
(10) Pub. No.: US 2017/0308550 A1
(43) Pub. Date: Oct. 26, 2017

(54) VISUALIZING RELEVANT DOCUMENTS AND PEOPLE WHILE VIEWING A DOCUMENT ON A CAMERA-PROJECTOR TABLETOP SYSTEM

(71) Applicant: FUJI XEROX CO., LTD., Tokyo (JP)

(72) Inventors: Patrick Chiu, Mountain View, CA (US); Yifan Zhang, Yokohama (JP)

(21) Appl. No.: 15/137,390

(22) Filed: Apr. 25, 2016

(51) Int. Cl. G06F 17/30; G06F 3/0484; G06F 3/0481; H04N 5/232; G06K 9/00

(52) U.S. Cl. CPC G06F 17/30253; H04N 5/232; G06K 9/00456; G06F 3/04817; G06F 17/30274; G06F 3/04842; G06K 2209/01

(57) ABSTRACT

A computer-implemented method being performed in a computerized system comprising a processing unit, a memory, a projector and a camera, the projector and the camera positioned above a surface, the computer-implemented method comprising: using the camera to acquire an image of a document placed on the surface; using the acquired image of the document to obtain at least a portion of a text of the document; using the obtained at least the portion of the text of the document to find a plurality of documents relevant to the document; using the obtained at least the portion of the text of the document to find a plurality of persons relevant to the document; and using the projector to display at least one of a first plurality of thumbnail images corresponding to the plurality of relevant documents and at least one of a second plurality of thumbnail images corresponding to the plurality of relevant persons.

### BACKGROUND OF THE INVENTION

### Technical Field

The disclosed embodiments relate in general to technology for interacting with documents and, more specifically, to systems and methods for visualizing relevant documents and people while viewing a document on a camera-projector tabletop system.

### Description of the Related Art

As it is well known to persons of ordinary skill in the art, normal tabletops can be turned into an interactive computer displays by mounting a projector and camera above the table. Early research systems such as the DigitalDesk described by Wellner, P. The DigitalDesk calculator: tangible manipulation on a desk top display. Proc. UIST '91, pp. 27-33 and CamWorks described by Newman, W., Dance, C., Taylor, A., Taylor, S., Taylor, M., Aldhous, T. (1999) CamWorks: a video-based tool for efficient capture from paper source documents. Proc. Intl. Conf. on Multimedia Computing and Systems (ICMCS '99), pp 647-653 demonstrated this concept. Some systems supported finger and gesture input using video camera, see Pinhanez, C., Kjeldsen, R., Tang, L., Levas, A., Podlaseck, M., Sukaviriya, N. and Pingali, G. Creating touch-screens anywhere with interactive projected displays. Proc. ACM Multimedia '03 (Demo), pp. 460-461, while more recent ones employed depth cameras, see Kane, S. K., Avrahami, D., Wobbrock, J. O., Harrison, B., Rea, A. D., Philipose, M., LaMarca, A. Bonfire: a nomadic system for hybrid laptop-tabletop interaction, Proc. UIST '09, pp. 129-138.

In a scenario in which the user is reading a document placed on a tabletop, it would be desirable to automatically analyze the content of the document and provide the user with certain additional information using the aforesaid interactive tabletop. Thus, new and improved systems and methods adaptable for this purpose are needed.

### SUMMARY OF THE INVENTION

The embodiments described herein are directed to methods and systems that substantially obviate one or more of the above and other problems associated with the conventional technology for interacting with documents.

In accordance with one aspect of the inventive concepts described herein, there is provided a computer-implemented method being performed in a computerized system comprising a processing unit, a memory, a projector and a camera, the projector and the camera positioned above a surface, the computer-implemented method involving: using the camera to acquire an image of a document placed on the surface; using the acquired image of the document to obtain at least a portion of a text of the document; using the obtained at least the portion of the text of the document to find a plurality of documents relevant to the document; using the obtained at least the portion of the text of the document to find a plurality of persons relevant to the document; and using the projector to display at least one of a first plurality of thumbnail images corresponding to the plurality of relevant documents and at least one of a second plurality of thumbnail images corresponding to the plurality of relevant persons.

In one or more embodiments, the camera is mounted on a turret operatively coupled to the processing unit and wherein the processing unit is configured to cause the turret to move the camera to locate the document on the surface.

In one or more embodiments, using the acquired image of the document to obtain at least the portion of the text of the document comprises performing an optical character recognition on the acquired image of the document to obtain at least the portion of the text of the document.

In one or more embodiments, an entire text of the document is obtained by performing an optical character recognition on the acquired image of the document.

In one or more embodiments, using the acquired image of the document to obtain at least the portion of the text of the document comprises determining keypoints in the acquired image of the document, matching the determined keypoints to keypoints of a collection of electronic documents, locating a matching electronic document in the collection of electronic documents with matching keypoints and extracting the at least the portion of the text of the document from the located matching electronic document.

In one or more embodiments, each of the first plurality of thumbnail images corresponding to the plurality of relevant documents is extracted from the corresponding one of the plurality of relevant documents.

In one or more embodiments, extracting the thumbnail image from the corresponding relevant document comprises extracting a plurality of pictures from the corresponding relevant document using picture detection and selecting one of the extracted plurality of pictures as the thumbnail image.

In one or more embodiments, the selected picture of the document has most unique color and texture features with respect to pictures from other documents in the collection.

In one or more embodiments, using the obtained at least the portion of the text of the document to find a plurality of persons relevant to the document comprises performing a web search using the at least the portion of the text of the document.

In one or more embodiments, the second plurality of thumbnail images corresponding to the plurality of relevant persons is obtained by locating a plurality of photos of each of the plurality of persons relevant to the document and automatically selecting a single photo of each of the plurality of persons relevant to the document as the corresponding thumbnail image.

In one or more embodiments, the selected single photo has color and texture features closest to its centroid from the plurality of photos of each of the plurality of persons relevant to the document.

In one or more embodiments, the projector and the camera are parts on a head-mounted augmented reality system worn by a user.

In one or more embodiments, the projector is rigidly mounted above the surface and wherein the at least one of the first plurality of thumbnail images corresponding to the plurality of relevant documents and at least one of the second plurality of thumbnail images corresponding to the plurality of relevant persons are displayed on the surface by the projector.

In one or more embodiments, the method further comprises detecting a selection by a user of the at least one of a first plurality of thumbnail images corresponding to the plurality of relevant documents and displaying information on the corresponding relevant document.

In one or more embodiments, the method further comprises detecting a selection by a user of the at least one of a first plurality of thumbnail images corresponding to the plurality of relevant documents and displaying the corresponding relevant document.

In one or more embodiments, the method further comprises detecting a selection by a user of the at least one of a second plurality of thumbnail images corresponding to the plurality of relevant persons and displaying information on the corresponding relevant person.

In one or more embodiments, the method further comprises detecting a selection by a user of the at least one of a second plurality of thumbnail images corresponding to the plurality of relevant persons and enabling a user to contact the corresponding relevant person.

In one or more embodiments, the surface is a tabletop.

In accordance with another aspect of the inventive concepts described herein, there is provided a non-transitory computer-readable medium embodying a set of computer-executable instructions, which, when executed in a computerized system comprising a processing unit, a memory, a camera and a projector, the camera and the projector being positioned above a surface, cause the computerized system to perform a method involving: using the camera to acquire an image of a document placed on the surface; using the acquired image of the document to obtain at least a portion of a text of the document; using the obtained at least the portion of the text of the document to find a plurality of documents relevant to the document; using the obtained at least the portion of the text of the document to find a plurality of persons relevant to the document; and using the projector to display at least one of a first plurality of thumbnail images corresponding to the plurality of relevant documents and at least one of a second plurality of thumbnail images corresponding to the plurality of relevant persons.

In accordance with yet another aspect of the inventive concepts described herein, there is provided a computerized system comprising a processing unit, a memory, a camera and a projector, the camera and the projector being positioned above a surface, the memory storing a set of computer-executable instructions causing the computerized system to perform a method involving: using the camera to acquire an image of a document placed on the surface; using the acquired image of the document to obtain at least a portion of a text of the document; using the obtained at least the portion of the text of the document to find a plurality of documents relevant to the document; using the obtained at least the portion of the text of the document to find a plurality of persons relevant to the document; and using the projector to display at least one of a first plurality of thumbnail images corresponding to the plurality of relevant documents and at least one of a second plurality of thumbnail images corresponding to the plurality of relevant persons.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates one exemplary embodiment of a system for visualizing relevant documents and people while viewing a document on a camera-projector tabletop system.

FIG. 2 provides an exemplary illustration of the visualization of relevant documents and persons by the system for visualizing relevant documents and people while viewing a document on a camera-projector tabletop system.

FIG. 3 illustrates an exemplary embodiment of a system using augmented reality device for visualization of relevant documents and persons.

FIG. 4 provides an exemplary illustration of the visualization of relevant documents and persons by the system employing an augmented reality device such as Google Glass, with a translucent screen showing thumbnails of relevant documents and people.

FIG. 5 illustrates an exemplary operating sequence of the system for visualizing relevant documents and people while viewing a document on a camera-projector tabletop system.

FIG. 6 illustrates an exemplary embodiment of a computerized system for visualizing relevant documents and people while viewing a document on a camera-projector tabletop system.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In the scenario where a user is reading a paper document (or a digital document on a tablet), an embodiment of the inventive system can help the user find relevant documents and people and display them on the tabletop near the document. In one or more embodiments, this is achieved by using a high resolution camera above the table to capture the document and using the OCR text to query for relevant documents and people, extracting representative pictures from the relevant documents and finding photos of the relevant people, and projecting these as thumbnails on the tabletop. In various embodiments, a document thumbnail may be selected to show more info about the document or to retrieve the document, and a person thumbnail may be selected to show more info about the person or to contact the person.

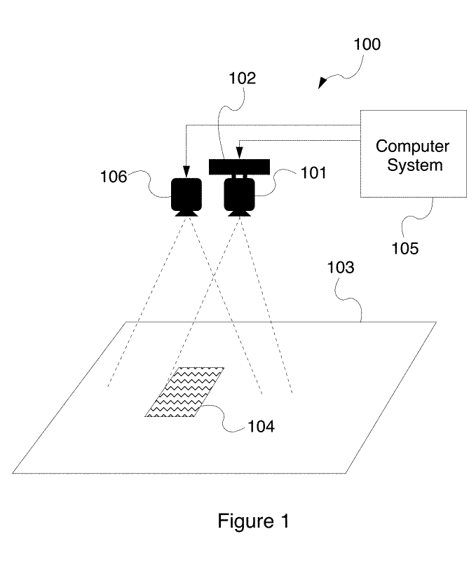

FIG. 1 illustrates one exemplary embodiment of a system 100 for visualizing relevant documents and people while viewing a document on a camera-projector tabletop system. In one or more embodiments, the described system 100 for visualizing relevant documents and people while viewing a document on a camera-projector tabletop system incorporates a high-resolution (e.g. 4K) camera 101 mounted on an optional pan-tilt robotic turret 102 above a tabletop or other surface 103. The optional robotic turret 102 moves the camera 101 to search for document(s) 104 placed anywhere on the tabletop 103. Once the document(s) 104 are detected, the camera 101 is moved by the robotic turret 102 to point at the detected document pages to capture high-resolution images of the document(s) 104. These high-resolution images are, in turn, used by an OCR engine executing on a computerized system 105 to convert captured document content to text. In an alternative embodiment, the pan-tilt robotic turret 102 is not provided and the camera 101 is rigidly mounted above the tabletop 103 such as to have the entire tabletop 103 within its field of view. In various embodiments, the document 104 may be in the form of a physical paper or of a tablet computer displaying digital content.

In one or more embodiments, the imaging resolution of the camera 101 is at least 4096×2160 pixels. However, as would be appreciated by persons of ordinary skill in the art, the invention is not limited to a specific resolution of the camera 101 and cameras with any other suitable resolution may be used. In one or more embodiments, the distance from the camera 101 to the center of the tabletop 103 is calculated such as to achieve the resolution of about 300 dpi of the acquired image of the document 104 with approximately 20 pixels x-height to achieve optimal OCR performance.

In addition to the camera 101, the system 100 for visualizing relevant documents and people while viewing a document on a camera-projector tabletop system incorporates a projector 106 configured to project content onto the tabletop or other surface 103. To this end, the projector 106 is communicatively coupled with the computerized system 105. In one or more embodiments, the system 100 is configured to help the user find relevant documents and people and display them on the tabletop 103 near the document. Finding relevant documents while reading is one of the ways to support “active reading,” as described, for example, in Schilit, B. N., Golovchinsky, G., Price, M. N. Beyond paper: supporting active reading with free form digital ink annotations. Proc. CHI '98, pp. 249-256, incorporated herein by reference. Finding relevant people is especially applicable to the case where the document collection is from an organization where the user is a member and can easy contact the people. To facilitate the finding of relevant documents and persons, the computerized system 105 may be connected to the Internet and/or one or more local and/or remote database systems or services or search engines for performing relevant persons and documents searching. In one or more embodiments, the system 100 uses the aforesaid OCR text of the document as a search query to find relevant documents and/or persons in a respective collection.

In one embodiment, the document 104 may be displayed using a tablet computer, which shows to the user an electronic version of the document 104. In this embodiment, a lower resolution camera 101 may be used. While the camera cannot capture the document for performing the OCR operation, the image captured by the camera 101 may be used to produce a set of keypoints that can be matched to the keypoints of a document in the collection, as described, for example, in Liao, C., Tang, H., Liu, Q., Chiu, P., Chen, F. FACT: Fine-grained cross-media interaction with documents via a portable hybrid paper-laptop interface. Proc. ACM Multimedia 2010, pp. 361-370, incorporated herein by reference. After the corresponding electronic document has been found, its text can be obtained from the electronic (e.g. PDF or Word) version of the document and used for the aforesaid search query to the remote search engine or database system without the need to perform the OCR.

In one or more embodiments, from the query, the relevant documents and people can be found by using standard similarly measures on the collection of document metadata, as described, for example, in Lim, S., Chiu, P. Collaboration Map: Visualizing temporal dynamics of small group collaboration. CSCW 2015 Companion (Demo), pp. 41-44, incorporated herein by reference. Using the described system, called CoMap, the relevant people are identified by co-authorship relations. Thus, by matching the query to the documents, the system can obtain a set of relevant documents. From these relevant documents, in one embodiment, a list of the top M documents and top N people is derived.

In one or more embodiments, the system 100 for visualizing relevant documents and people while viewing a document on a camera-projector tabletop system is configured to extract pictures from a found document for the visualization on the interactive tabletop. For each relevant document found using the aforesaid query, a representative picture can be used to display a thumbnail using the projector 106. As would be appreciated by persons of ordinary skill in the art, there are different ways to extract pictures depending on the format of the electronic document. Many documents are stored in PDF format, but the document content may be encoded in various ways such as by way of embedded image elements or as a scanned page image. Exemplary embodiments of techniques for extracting the pictures from the documents will be described in detail below.

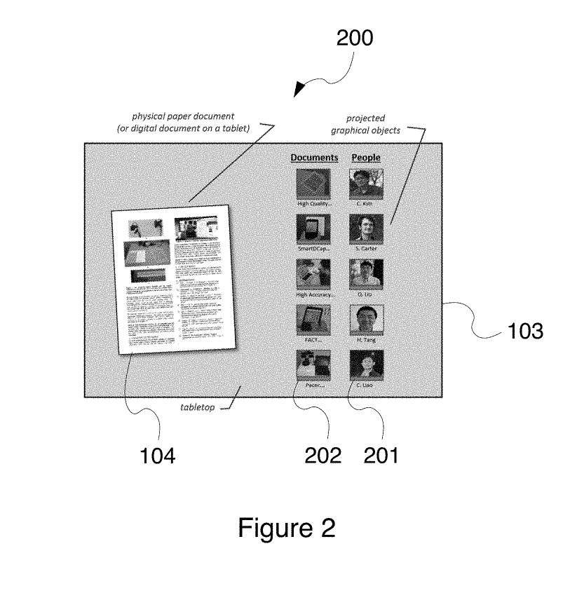

FIG. 2 provides an exemplary illustration of the visualization 200 of relevant documents and persons by the system 100 for visualizing relevant documents and people while viewing a document on a camera-projector tabletop system. The visualization 200 is created by the system 100 on the tabletop 103 using the projector 106. As shown in FIG. 2, the system 100 is configured to display relevant persons 201 and relevant documents 202 next to the document 104 placed on the tabletop 103. In various embodiments, the thumbnail images representing relevant documents 202 and the relevant persons 201 are arranged into two columns adjacent to one another and to the document 104.

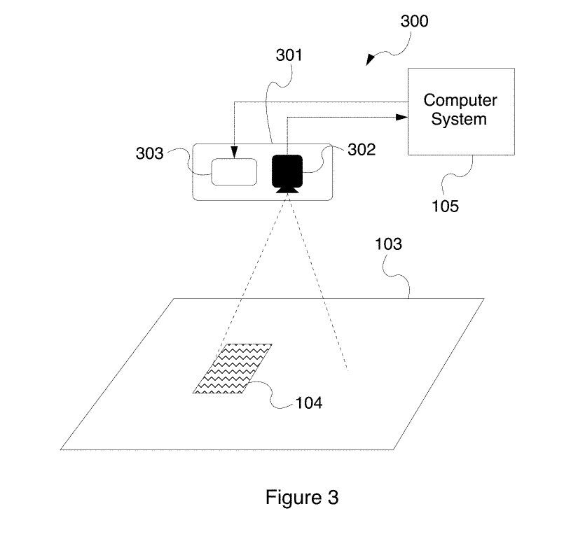

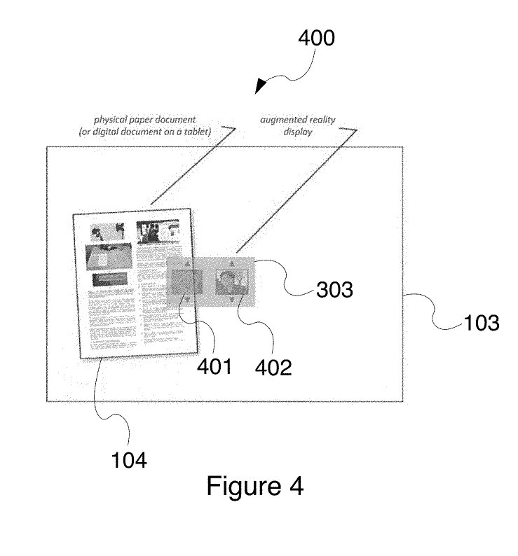

In another embodiment, a mobile device, such as a smartphone or a tablet or an augmented reality device, such as Google Glass is employed for visualizing of relevant documents and persons. An exemplary embodiment of a system 300 using augmented reality device for visualization of relevant documents and persons is illustrated in FIG. 3. In the system 300, a user is viewing the document 104 placed on the tabletop 103 using an augmented reality device 301. In this embodiment, the camera 302 and display 303 are part of the single augmented reality device 301 (unlike with the tabletop system embodiment 100 illustrated in FIG. 1, where the projector 106 and camera 101 are separate and distinct). In this embodiment, when the user views the paper document 104, the augmented reality device 301 can overlay relevant information on the translucent screen. FIG. 4 provides an exemplary illustration of the visualization 400 of relevant documents and persons by the system 300 employing an augmented reality device 301 such as Google Glass, with a translucent screen showing thumbnails of relevant documents 401 and people 402. In one embodiment, because the screen real estate is limited, it only shows one row with two thumbnails of one relevant document and one person, and the user is provided with an interface to scroll up or down the ranked list of thumbnails.

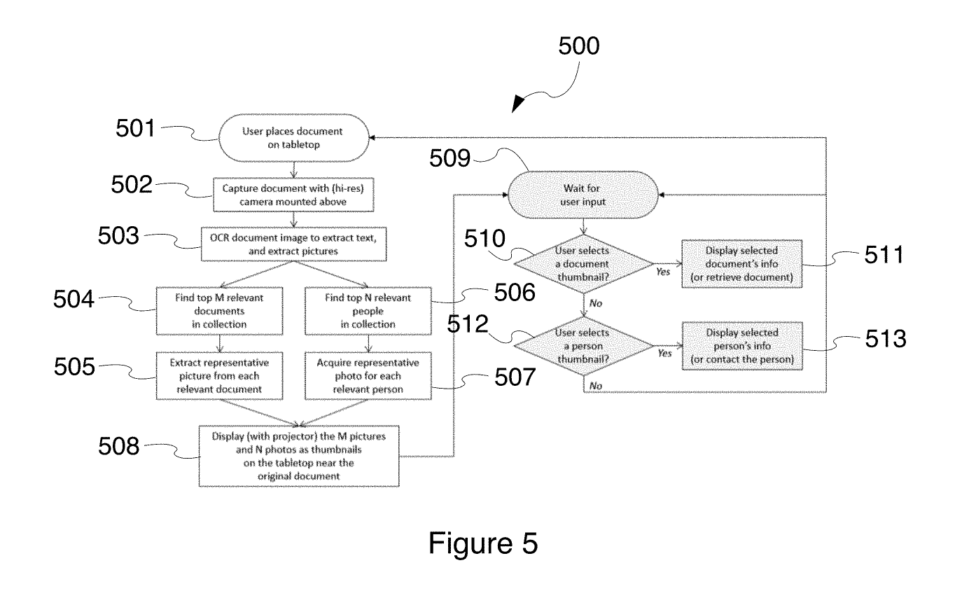

FIG. 5 illustrates an exemplary operating sequence 500 of the system 100 for visualizing relevant documents and people while viewing a document on a camera-projector tabletop system. First, at step 501, the user placed the document 104 on the tabletop 103. At step 502, a high-resolution image of the document is captured with a high-resolution camera mounted above the tabletop. At step 503, OCR of the imaged document is performed to extract document text as well as pictures. At step 504, top M relevant document in a document collection are found based on the extracted document text. At step 505, a representative picture is extracted from each of the M relevant documents. At step 506, top N relevant people in the collection are identified. At step 507, a representative photo of each relevant person is acquired. At step 508, the M representative document pictures and N photos of relevant people are displayed as thumbnails on the tabletop next to the document.

At step 509, the system 100 awaits user input. At step 510, the system 100 determines if the user selected a document thumbnail. If so, at step 511, the information on the selected document is retrieved and displayed to the user or the entire document is retrieved and displayed. At step 512, the system 100 determines if the user selected a person thumbnail. If so, at step 513, the system retrieves and displays the information on the selected person or his contact information. The user may be also provided with an option to contact the selected person.

Now, the technique used for extracting the pictures from the relevant documents for visualization will be described in detail. In the below description, it is assumed that the documents in the collection are in PDF format. The challenge is that the PDF content may be encoded in various ways such as embedded image elements or as a scanned page image. In the former case, the system 100 may use a software tool such as PyPDF2 to extract thumbnail photos from documents. In the latter case, the system 100 can first extract the page as an image using a software tool such as Xpdf, also described in the last reference, and then apply document image analysis techniques such as layout analysis or picture detection, see, for example, Chiu, P., Chen, F., Denoue, L. Picture detection in document page images. Proc. ACM DocEng 2010, pp. 211-214.

In one or more embodiments, to find a representative thumbnail picture for a relevant document, one of its extracted pictures is automatically selected. In one exemplary embodiment, the system 100 selects the picture image that has the most unique color and texture features from its set of extracted pictures and also from the extracted pictures of all the documents in the collection.

In one or more embodiments, to find representative thumbnail photo for a relevant person, one of his or her photos is automatically selected. To obtain photo thumbnails for a relevant person, organizations often have member photos on a website or in a database. A web search can also be used to find photos of the people. Once a set of photos has been acquired for a particular person, one way to compute the representative thumbnail photo is to determine the photo image that has color and texture features closest to its centroid from its set of photos. Also, it can also take into account other people by selecting representative photos for each person to be visually as different as possible from the other people's representative photos in the collection. In one or more embodiments, when there are no pictures or photos, the first page image or a generic photo icon can be used. In one embodiment, once the top M pictures and top N people have be obtained, they are laid out in a visualization and projected onto the tabletop, as shown in FIG. 2.

To interact with these thumbnails, finger and hand gestures may be used, as described, for example, in Pinhanez, C., Kjeldsen, R., Tang, L., Levas, A., Podlaseck, M., Sukaviriya, N. and Pingali, G. Creating touch-screens anywhere with interactive projected displays. Proc. ACM Multimedia '03 (Demo), pp. 460-461 and Kane, S. K., Avrahami, D., Wobbrock, J. O., Harrison, B., Rea, A. D., Philipose, M., LaMarca, A. Bonfire: a nomadic system for hybrid laptop-tabletop interaction. Proc. UIST '09, pp. 129-138, incorporated herein by reference. In one embodiment, when a document thumbnail 202 is selected (the equivalent of a tap gesture), information about the document (e.g. title, author, date, etc.) is displayed, or alternatively the document can be retrieved and viewed in a pop up window. When a person thumbnail 201 is selected, contact information can be displayed, or alternatively the person can be contacted (via email, text message, audio conference, video conference, etc.).

### Exemplary Computer Platform

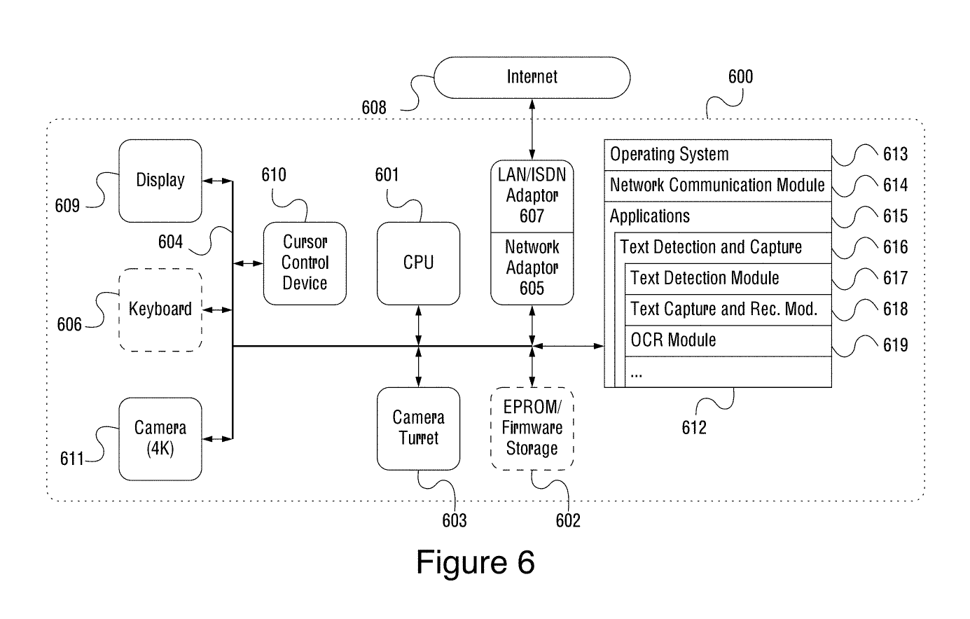

FIG. 6 illustrates an exemplary embodiment of a computerized system 600 for visualizing relevant documents and people while viewing a document on a camera-projector tabletop system. In one or more embodiments, the computerized system 600 may be implemented within the form factor of a desktop computer, well known to persons of skill in the art. In an alternative embodiment, the computerized system 600 may be implemented based on a laptop or a notebook computer, a tablet or a smartphone.

The computerized system 600 may include a data bus 604 or other interconnect or communication mechanism for communicating information across and among various hardware components of the computerized system 600, and a central processing unit (CPU or simply processor) 601 electrically coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also electrically coupled to the data bus 604, for displaying various information to a user of the computerized system 600, such as the captured text information described above. In an alternative embodiment, the display device 609 may be associated with a graphics controller and/or graphics processor (not shown). The display device 609 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 600. In an alternative embodiment, the display device 609 may be positioned outside of such enclosure, such as on the surface of a table or a desk. Also provided may be the camera turret 603 (element 102 in FIG. 1) incorporating various motors and/or actuators configured to move and/or rotate the camera 101 as described above. The camera turret 603 is also attached to the data bus 604.

In one or more embodiments, the computerized system 600 may incorporate one or more input devices, including cursor control devices, such as a mouse/pointing device 610, such as a mouse, a trackball, a touchpad, or cursor direction keys for communicating direction information and command selections to the processor 601 and for controlling cursor movement on the display 609. This input device typically has two degrees of freedom in two axes, a first axis (e.g., x) and a second axis (e.g., y), that allows the device to specify positions in a plane.

The computerized system 600 may further incorporate the high resolution camera 611 for acquiring images of the desk and documents thereon as described above, as well as a keyboard 606, which all may be coupled to the data bus 604 for communicating information, including, without limitation, images and video, as well as user commands (including gestures) to the processor 601.

In one or more embodiments, the computerized system 600 may additionally include a communication interface, such as a network adaptor 605 coupled to the data bus 604. The network adaptor 605 may be configured to establish a connection between the computerized system 600 and the Internet 608 using at least a local area network (LAN) and/or ISDN adaptor 607. The network adaptor 605 may be configured to enable a two-way data communication between the computerized system 600 and the Internet 608. The LAN adaptor 607 of the computerized system 600 may be implemented, for example, using an integrated services digital network (ISDN) card or a modem to provide a data communication connection to a corresponding type of telephone line, which is interfaced with the Internet 608 using Internet service provider's hardware (not shown). As another example, the LAN adaptor 607 may be a local area network interface card (LAN NIC) to provide a data communication connection to a compatible LAN and the Internet 608. In an exemplary implementation, the LAN adaptor 607 sends and receives electrical or electromagnetic signals that carry digital data streams representing various types of information.

In one or more embodiments, the Internet 608 typically provides data communication through one or more sub-networks to other network resources. Thus, the computerized system 600 is capable of accessing a variety of network resources located anywhere on the Internet 608, such as remote media servers, web servers, other content servers as well as other network data storage resources. In one or more embodiments, the computerized system 600 is configured to send and receive messages, media and other data, including application program code, through a variety of network(s) including the Internet 608 by means of the network interface 605. In the Internet example, when the computerized system 600 acts as a network client, it may request code or data for an application program executing on the computerized system 600. Similarly, it may send various data or computer code to other network resources.

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, the described embodiments of the invention are not limited to any specific combination of hardware circuitry and/or software.

The term “computer-readable medium” as used herein refers to any medium that participates in providing instructions to the processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to the processor 601 for execution. For example, the instructions may initially be carried on a magnetic disk from a remote computer. Alternatively, a remote computer can load the instructions into its dynamic memory and send the instructions over the Internet 608. Specifically, the computer instructions may be downloaded into the memory 612 of the computerized system 900 from the foresaid remote computer via the Internet 608 using a variety of network data communication protocols well known in the art.

In one or more embodiments, the memory 612 of the computerized system 600 may store any of the following software programs, applications or modules:

1. Operating system (OS) 613 for implementing basic system services and managing various hardware components of the computerized system 600. Exemplary embodiments of the operating system 613 are well known to persons of skill in the art, and may include any now known or later developed mobile operating systems.

2. Network communication module 614 may incorporate, for example, one or more network protocol stacks which are used to establish a networking connection between the computerized system 600 and the various network entities of the Internet 608, using the network adaptor 605.

2. Applications 615 may include, for example, a set of software applications executed by the processor 601 of the computerized system 600, which cause the computerized system 600 to perform certain predetermined functions, such as acquire images of the desk and documents thereon using the camera 611, using the techniques described above. In one or more embodiments, the applications 615 may include the inventive application 616 incorporating the functionality described above.

In one or more embodiments, the inventive text detection and capture application 616 incorporates a text detection module 617 for capturing images of the paper or electronic documents 104. In addition, the inventive text detection and capture application 616 may incorporate a document page capture and reconstruction module 618 for performing document page capture and reconstruction. Further provided may be OCR module 619 for converting captured page images into text. Optionally, other applications deployed in the memory 612 of the system 600 may include indexing and search system, document repository and/or language translation application (not shown), which may receive the text generated by the OCR module 619.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for visualizing relevant documents and people while viewing a document on a camera-projector tabletop system. It is intended that the specification and examples be considered as exemplary only, with a true scope and spirit of the invention being indicated by the following claims.

What is claimed is:

1. A computer-implemented method being performed in a computerized system comprising a processing unit, a memory, a projector and a camera, the projector and the camera positioned above a surface, the computer-implemented method comprising:
a. using the camera to acquire an image of a document placed on the surface;
b. using the acquired image of the document to obtain at least a portion of a text of the document;
c. using the obtained at least the portion of the text of the document to find a plurality of documents relevant to the document;
d. using the obtained at least the portion of the text of the document to find a plurality of persons relevant to the document; and
e. using the projector to display at least one of a first plurality of thumbnail images corresponding to the plurality of relevant documents and at least one of a second plurality of thumbnail images corresponding to the plurality of relevant persons.

2. The computer-implemented method of claim 1, wherein the camera is mounted on a turret operatively coupled to the processing unit and wherein the processing unit is configured to cause the turret to move the camera to locate the document on the surface.

3. The computer-implemented method of claim 1, wherein using the acquired image of the document to obtain at least the portion of the text of the document comprises performing an optical character recognition on the acquired image of the document to obtain at least the portion of the text of the document.

4. The computer-implemented method of claim 1, wherein in step b., an entire text of the document is obtained by performing an optical character recognition on the acquired image of the document.

5. The computer-implemented method of claim 1, wherein using the acquired image of the document to obtain at least the portion of the text of the document comprises determining keypoints in the acquired image of the document, matching the determined keypoints to keypoints of a collection of electronic documents, locating a matching electronic document in the collection of electronic documents with matching keypoints and extracting the at least the portion of the text of the document from the located matching electronic document.

6. The computer-implemented method of claim 1, wherein each of the first plurality of thumbnail images corresponding to the plurality of relevant documents is extracted from the corresponding one of the plurality of relevant documents.

7. The computer-implemented method of claim 6, wherein extracting the thumbnail image from the corresponding relevant document comprises extracting a plurality of pictures from the corresponding relevant document using picture detection and selecting one of the extracted plurality of pictures as the thumbnail image.

8. The computer-implemented method of claim 7, wherein the selected picture of the document has most unique color and texture features with respect to pictures from other documents in the collection.

9. The computer-implemented method of claim 1, wherein using the obtained at least the portion of the text of the document to find a plurality of persons relevant to the document comprises performing a web search using the at least the portion of the text of the document.

10. The computer-implemented method of claim 1, wherein the second plurality of thumbnail images corresponding to the plurality of relevant persons is obtained by locating a plurality of photos of each of the plurality of persons relevant to the document and automatically selecting a single photo of each of the plurality of persons relevant to the document as the corresponding thumbnail image.

11. The computer-implemented method of claim 10, wherein the selected single photo has color and texture features closest to its centroid from the plurality of photos of each of the plurality of persons relevant to the document.

12. The computer-implemented method of claim 1, wherein the projector and the camera are parts on a head-mounted augmented reality system worn by a user.

13. The computer-implemented method of claim 1, wherein the projector is rigidly mounted above the surface and wherein the at least one of the first plurality of thumbnail images corresponding to the plurality of relevant documents and at least one of the second plurality of thumbnail images corresponding to the plurality of relevant persons are displayed on the surface by the projector.

14. The computer-implemented method of claim 1, further comprising detecting a selection by a user of the at least one of a first plurality of thumbnail images corresponding to the plurality of relevant documents and displaying information on the corresponding relevant document.

15. The computer-implemented method of claim 1, further comprising detecting a selection by a user of the at least one of a first plurality of thumbnail images corresponding to the plurality of relevant documents and displaying the corresponding relevant document.

16. The computer-implemented method of claim 1, further comprising detecting a selection by a user of the at least one of a second plurality of thumbnail images corresponding to the plurality of relevant persons and displaying information on the corresponding relevant person.

17. The computer-implemented method of claim 1, further comprising detecting a selection by a user of the at least one of a second plurality of thumbnail images corresponding to the plurality of relevant persons and enabling a user to contact the corresponding relevant person.

18. The computer-implemented method of claim 1, wherein the surface is a tabletop.

19. A non-transitory computer-readable medium embodying a set of computer-executable instructions, which, when executed in a computerized system comprising a processing unit, a memory, a camera and a projector, the camera and the projector being positioned above a surface, cause the computerized system to perform a method comprising:
a. using the camera to acquire an image of a document placed on the surface;
b. using the acquired image of the document to obtain at least a portion of a text of the document;
c. using the obtained at least the portion of the text of the document to find a plurality of documents relevant to the document;
d. using the obtained at least the portion of the text of the document to find a plurality of persons relevant to the document; and
e. using the projector to display at least one of a first plurality of thumbnail images corresponding to the plurality of relevant documents and at least one of a second plurality of thumbnail images corresponding to the plurality of relevant persons.

20. A computerized system comprising a processing unit, a memory, a camera and a projector, the camera and the projector being positioned above a surface, the memory storing a set of computer-executable instructions causing the computerized system to perform a method comprising:
a. using the camera to acquire an image of a document placed on the surface;
b. using the acquired image of the document to obtain at least a portion of a text of the document;
c. using the obtained at least the portion of the text of the document to find a plurality of documents relevant to the document;
d. using the obtained at least the portion of the text of the document to find a plurality of persons relevant to the document; and
e. using the projector to display at least one of a first plurality of thumbnail images corresponding to the plurality of relevant documents and at least one of a second plurality of thumbnail images corresponding to the plurality of relevant persons.
